(19) United States
(12) Patent Application Publication
(10) Pub. No.: US 2025/0146933 A1
(43) Pub. Date: May 8, 2025

(54) SPATIALLY RESOLVED NIR SPECTROMETER

(71) Applicant: TRINAMIX GMBH, Ludwigshafen Am Rhein (DE)

(72) Inventors: Michael HANKE, Ludwigshafen am Rhein (DE); Florian PROELL, Ludwigshafen am Rhein (DE)

(21) Appl. No.: 18/832,956

(22) PCT Filed: Feb. 23, 2023
(86) PCT No.: PCT/EP2023/054536

§ 371 Date: Jul. 25, 2024

(30) Foreign Application Priority Data
Feb. 24, 2022 (EP) 22158610.0

(51) Int. Cl. G01N 21/359; G01N 21/17; G01N 21/35; G01N 21/3563; G01N 21/84

(52) U.S. Cl. CPC G01N 21/359; G01N 21/3563; G01N 2021/1776; G01N 2021/3595; G01N 2021/8466; G01N 2201/0221; G01N 2201/1296

(57) ABSTRACT

Disclosed herein is a method of obtaining at least one item of object information on at least one object by spectroscopic measurement. The method includes the following steps:
i. acquiring spectroscopic data by using at least one spectrometer device;
ii. acquiring, by using at least one imaging device image data of a scene within a field of view of the imaging device, the scene including at least a part of the object and at least a part of the spatial measurement range of the spectrometer device; and
iii. evaluating the spectroscopic data of step i. and at least one item of image information derived from the image data of step ii., for obtaining the at least one item of object information on the at least one object.

### TECHNICAL FIELD

The present invention relates to a method of obtaining at least one item of object information on at least one object by spectroscopic measurement. Further, the present invention relates to a system for obtaining at least one item of object information on at least one object by spectroscopic measurement, and to a computer program and a computer-readable storage medium comprising instructions for performing the method. The method and devices can, in particular, be used for acquiring chemical information, specifically information on a chemical composition, of the object and may in particular be used for the analysis of inhomogeneous objects.

### BACKGROUND ART

Spectrographic methods are widely used in research, industry and customer applications, enabling multiple applications such as optical analysis and/or quality control. Use cases can be found, for example, in the fields of food production and quality control, farming, pharma, medical applications, life sciences and many more. Various methods are available, such as photometry, absorption, fluorescence and Raman spectrometry, enabling qualitative and/or quantitative sample analysis. These methods usually involve acquiring spectroscopic data of an object, also referred to as sample, by using at least one spectrometer device, which may in particular comprise at least one wavelength-selective element and at least one detector device.

US 2019/0033210 A1 discloses a system and methods that may qualify plant material. A system for qualifying plant material may include an inspection zone, a support stage configured to support the plant material in the inspection zone, at least one camera configured to acquire at least one image of the plant material in the inspection zone, at least one processor configured to receive and analyze the camera image to identify a region of interest containing specific plant structures possessing active component, and at least one spectrometer configured to acquire a spectrometric measurement of the plant material in the inspection zone. The at least one processor may be further configured to facilitate a spectrometric measurement of the specific plant structures identified in the camera image, and to enable output of an indicator of a quality measure of the plant material based on the spectrometric measurement of the specific plant structures identified in the camera image.

US 2018/172510 A1 describes a system for analyzing food in a kitchen appliance for one or more of identifying the food, determining nutritional information of the food, and/or monitoring the readiness status of the food. The system may comprise a spectrometer apparatus integrated with the kitchen appliance such as an oven, or spaced apart from the kitchen appliance. The system may comprise a compound parabolic concentrator or a concentrating lens coupled to a spectrometer module and an illumination module of the apparatus. The system may comprise a respective compound parabolic concentrator or a concentrating lens coupled to each of the spectrometer module and illumination module for analyzing food at close range.

US 2016/150213 A1 provides a method and system for using one or more sensors configured to capture two-dimensional and/or three dimensional image data of one or more objects. In particular, the method and system combine one or more digital sensors with visible and near infrared illumination to capture visible and nonvisible range spectral image data for one or more objects. The captured spectral image data can be used to separate and identify the one or more objects. Additionally, the three-dimensional image data can be used to determine a volume for each of the one or more objects. The identification and volumetric data for one or more objects can be used individually or in combination to obtain characteristics about the objects. The method and system provide the user with the ability to capture images of one or more objects and obtain related characteristics or information about each of the one or more objects.

US 2019/026586 A1 discloses a portable complete analysis solution that integrates computer vision, spectrometry, and artificial intelligence for providing self-adaptive, real time information and recommendations for objects of interest. The solution has three major key components: (1) a camera enabled mobile device to capture an image of the object, followed by fast computer vision analysis for features and key elements extraction; (2) a portable wireless spectrometer to obtain spectral information of the object at areas of interest, followed by transmission of the data (data from all built in sensors) to the mobile device and the cloud; and (3) a sophisticated cloud based artificial intelligence model to encode the features from images and chemical information from spectral analysis to decode the object of interest. The complete solution provides fast, accurate, and real time analyses that allows users to obtain clear information about objects of interest as well as personalized recommendations based on the information.

Spectroscopic methods, such as near-infrared (NIR) spectroscopy, and chemometric methods may in particular be applied to obtain the chemical composition of the sample. Such samples may, in particular, be inhomogeneous samples, whose chemical composition may strongly depend on the exact position within the sample. Examples of inhomogeneous samples may comprise food items, e.g. fruits and/or vegetables.

Specific challenges of spectroscopic measurements may arise in inhomogeneous samples. These measurements may comprise measuring several individual spots of the inhomogeneous sample to obtain an average chemical composition of the sample. Alternatively, the sample may be moved, e.g. rotated, during integration of an individual measurement. While both approaches gather more global parameters of the sample, they typically reduce accuracy of the measurements, since information on a spatial variation of the chemical composition may be lost by the averaging process.

Thus, despite the progress which has been made in the field of spectroscopic sample analysis over the recent years, in particular with regard to determining the chemical sample composition, several challenges remain. Specifically, means and methods are desired which allow for obtaining accurate spectroscopic data of an object by taking into account possible local variations and inhomogeneity of the object.

### Problem to be Solved

It is therefore desirable to provide a means and methods, which address the above-mentioned technical challenges in the field of spectroscopic sample analysis. Specifically, means and methods shall be provided which allow for obtaining accurate spectroscopic data of an object by taking into account possible local variations and inhomogeneity of the object.

### SUMMARY

This problem is addressed by a method of obtaining at least one item of object information on at least one object by spectroscopic measurement, a system for obtaining at least one item of object information on at least one object by spectroscopic measurement, a computer program and a computer-readable storage medium, with the features of the independent claims. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method of obtaining at least one item of object information on at least one object by spectroscopic measurement is disclosed. The method comprises the following method steps, which specifically may be performed in the given order. However, a different order is also possible. The method may further comprise additional method steps, which are not listed. Further, one or more or even all of the method steps may be performed only once or repeatedly.

The method comprises the following steps:
i. acquiring spectroscopic data, specifically of the at least one object, by using at least one spectrometer device, within at least one spatial measurement range of the spectrometer device;
ii. acquiring, by using at least one imaging device, specifically a camera, image data of a scene within a field of view of the imaging device, the scene comprising at least a part of the object and at least a part of the spatial measurement range of the spectrometer device; and
iii. evaluating the spectroscopic data of step i. and at least one item of image information derived from the image data of step ii., for obtaining the at least one item of object information on the at least one object.

The term “spectroscopic measurement” as used herein is a broad term and is to be given its ordinary and customary meaning to a person of ordinary skill in the art and is not to be limited to a special or customized meaning. The term specifically may refer, without limitation, to acquiring spectroscopic data on at least one object. The spectroscopic data may specifically be acquired by using at least one spectrometer device. As part of the spectroscopic measurement, the object may be illuminated with electromagnetic radiation in the infrared spectral range, specifically in the near infrared spectral range. In particular, the electromagnetic radiation may be in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm. The electromagnetic radiation may also be referred to as light, such that these two terms are be used interchangeably in this document. The spectroscopic measurement may further comprise receiving incident light after interaction with the object- and generating at least one corresponding signal, which may form part of the spectroscopic data. The spectroscopic data may comprise information on at least one optical property or optically measurable property of the object, which is determined as a function of the wavelength, for one or more different wavelengths. More specifically, the spectroscopic data may relate to at least one property characterizing at least one of a transmission, an absorption, a reflection and an emission of the object. The at least one optical property, may be determined for one or more wavelengths. The spectroscopic data may specifically take the form of a signal intensity determined as a function of the wavelength of the spectrum or a partition thereof, such as a wavelength interval, wherein the signal intensity may preferably be provided as an electrical signal, which may be used for further evaluation. Thus, the spectroscopic data may be generated as part of the spectroscopic measurement.

The term “acquiring spectroscopic data” as used herein is a broad term and is to be given its ordinary and customary meaning to a person of ordinary skill in the art and is not to be limited to a special or customized meaning. The term specifically may refer, without limitation, to an arbitrary process of at least one of capturing, recording and storing spectroscopic data by the spectrometer device, e.g. by measuring at least one of a transmission, an absorption, a reflection and an emission of the object as a function of the wavelength, for one or more different wavelengths.

The term “spectrometer device” as used herein is a broad term and is to be given its ordinary and customary meaning to a person of ordinary skill in the art and is not to be limited to a special or customized meaning. The term specifically may refer, without limitation, to an apparatus configured for acquiring spectroscopic data of at least one object within at least one spatial measurement range. The spectrometer device as used in step i. may in particular be a near-infrared spectrometer device. Thus, the spectrometer device may specifically be configured for detecting electromagnetic radiation in the near-infrared range. The spectrometer device may be configured for performing at least one spectroscopic measurement on the object. The spectrometer device may in particular comprise at least one detector device comprising at least one optical element and a plurality of photosensitive elements. The at least one optical element may specifically be configured for separating incident light, specifically electromagnetic radiation in the near-infrared range, into a spectrum of constituent wavelength components. Each photosensitive element may be configured for receiving at least a portion of one of the constituent wavelength components and for generating a respective detector signal depending on an illumination of the respective photosensitive element by the at least one portion of the respective constituent wavelength component. The detector signal, specifically the signal intensity, may together with the corresponding wavelength form part of the spectroscopic data. The spectrometer device may be or may comprise a dispersive spectrometer device that may analyze the radiation of an object illuminated with a broadband illumination, e.g. as described above. However, additionally or alternatively, further configurations and/or arrangements of the spectrometer device are feasible. As an example, the object may be illuminated with light of a limited number of different wavelengths and the spectrometer device may comprise a broadband detector. In particular, the spectrometer device may be a Fourier-Transform spectrometer, specifically a Fourier-Transform infrared spectrometer. Thus, narrow-band light sources may be used, such as at least one light emitting diode (LED) and/or at least one laser, for illuminating the object. Specifically, the spectrometer device may be configured for determining the spectrum by measuring and processing an interferogram, particularly by applying at least one Fourier transformation to the measured interferogram. The spectrometer device may in particular be embodied as a portable spectrometer device. Specifically, the spectrometer device may be part of a mobile device such as a notebook computer, a tablet or, specifically, a cell phone such as a smart phone. Additionally or alternatively, the mobile device may be or may comprise a smartwatch and/or a wearable computer, also referred to as wearable, e.g. a body-borne computer. Further mobile devices are feasible. The spectrometer device may be at least one of integrated into the mobile device or attachable thereto.

The term “spatial measurement range” as used herein is a broad term and is to be given its ordinary and customary meaning to a person of ordinary skill in the art and is not to be limited to a special or customized meaning. The term specifically may refer, without limitation, to a spatially limited section, which may be spectroscopically examined by the spectrometer device. As an example, the spatial measurement range may be defined as a solid angle or three-dimensional angular segment in space, wherein objects disposed within the solid angle or angular segment may be analyzed by the spectrometer device. A solid angle or angular segment, as an example, may be defined by geometric and/or optical properties of the spectrometer device. Thus, the spatial measurement range may be the field of view of the spectrometer device in which spectroscopic measurements may be performed. Thus, an object or a part of an object positioned within the spatial measurement range may be accessible to spectroscopic analysis by the spectrometer device. Specifically, the spectrometer device may be configured to acquire spectroscopic data on the basis of incident light from within the spatial measurement range. The spatial measurement range may in particular be a three-dimensional spatial section, e.g. a three-dimensional space, such as a cone-shaped spatial section, whose light content may be received and analyzed by the spectrometer device. The spectroscopic data acquired by the spectrometer device may comprise information relating to at least one object situated within the spatial measurement range of the spectrometer device. Specifically, for spectroscopically analyzing the object, the spectrometer device may be positioned in close proximity to the object, such that the spatial measurement range at least partially comprises the object, e.g. at a distance in the range from 0 mm to 100 mm from the object, specifically in the range from 0 mm to 15 mm.

The term “imaging device” as used herein is a broad term and is to be given its ordinary and customary meaning to a person of ordinary skill in the art and is not to be limited to a special or customized meaning. The term specifically may refer, without limitation, to an arbitrary device configured for recording or capturing image data and/or capturing 2D or 3D spatial information on at least one object and/or a scene. The imaging device may be or may comprise at least one camera having one or more imaging sensors, specifically one or more CCD or CMOS imaging sensors, for acquiring the image data. The camera may specifically comprise at least one camera chip, such as at least one CCD chip and/or at least one CMOS chip configured for recording images. The camera may comprise a one-dimensional or two-dimensional array of imaging sensors, such as pixels, which may e.g. be arranged on the camera chip. As an example, the camera may comprise at least 100 pixels in at least one dimension, such as at least 100 pixels in each dimension. As an example, the camera may comprise an array of imaging sensors comprising at least 100 imaging sensors in each dimension, specifically at least 300 imaging sensors in each dimension. For example, the camera may be a color camera, comprising color pixels, wherein each color pixel comprises at least three color sub-pixels sensitive for different colors. For example, the camera may comprise black and white pixels and/or color pixels. The color pixels and the black and white pixels may be combined internally in the camera. The camera may be a camera of a mobile device. The invention specifically shall be applicable to cameras as usually used in mobile devices such as notebook computers, tablets or, specifically, cell phones such as smart phones. Thus, specifically, the camera may be part of a mobile device which, besides the at least one camera, comprises one or more data processing devices such as one or more processors. The mobile device, specifically may have at least one function different from the spectroscopic function, such as a mobile communication function, e.g., the function of a cell phone. Other cameras, however, are feasible. As outlined above, the spectrometer device may also be part of a mobile device. In particular, both the camera and the spectrometer device may be part of the mobile device, specifically a smart phone. The camera, besides at least one camera chip or imaging chip, may comprise further elements, such as one or more optical elements, e.g. one or more lenses. As an example, the camera may be a fix-focus camera, having at least one lens, which is fixedly adjusted with respect to the camera. Alternatively, however, the camera may also comprise one or more variable lenses, which may be adjusted, automatically or manually. Alternatively or in addition, the imaging device may be or may comprise at least one LIDAR-based imaging device, wherein LIDAR stands for Light Detection and Ranging or Light Imaging, Detection and Ranging. The LIDAR-based imaging device may comprise at least on laser source, e.g. at least one tunable laser diode, for illuminating the object or at least one part of the object. The LIDAR-based imaging device may further comprise at least one localization unit configured for determining at least one distance of the illuminated part of the object from the imaging device and/or from at least one further point or location in space. The localization unit may in particular comprise at least one sensor element, e.g. a photo diode, configured for detecting at least one laser beam that was emitted from the laser source and reflected by the object. Determination of the distance, and thus generation of the image data as e.g. described below in more detail, may comprise processing the light beam reflected by the object and/or at least one reference light beam and/or the corresponding signals detected by the at least one sensor element.

The term “image data” as used herein is a broad term and is to be given its ordinary and customary meaning to a person of ordinary skill in the art and is not to be limited to a special or customized meaning. The term specifically may refer, without limitation, to spatially resolved one-dimensional, two-dimensional or even three-dimensional optical information. The image data may comprise a plurality of electronic readings from the imaging device, such as from the imaging sensors, e.g. the pixels of the camera chip, and/or from the sensor elements of the LIDAR-based imaging device. In particular, the image data may comprise a plurality of numerical values corresponding to the electronic readings from the imaging device. The electronic readings, specifically the numerical values, may relate to at least one optical property of at least one object within a field of view of the imaging device. Thus, the image data may comprise at least one array of information values, such as grey scale values and/or color information values. Alternatively or in addition, the information values comprised by the image data may comprise distance values, each indicating a distance between a part of the object and at least one reference point such as the imaging device, in particular the LIDAR-based imaging device.

The term “acquiring image data” as used herein is a broad term and is to be given its ordinary and customary meaning to a person of ordinary skill in the art and is not to be limited to a special or customized meaning. The term specifically may refer, without limitation, to an arbitrary process of capturing or recording image data by the imaging device, specifically the camera, e.g. in the form of electronic readings as generated by the imaging sensors in response to illumination.

The term “field of view” as used herein is a broad term and is to be given its ordinary and customary meaning to a person of ordinary skill in the art and is not to be limited to a special or customized meaning. The term specifically may refer, without limitation, to a spatially limited section, whose content may be imaged by the imaging device. Specifically, the image data generated by the imaging device may comprise spatially resolved optical information relating to the objects located within the field of view of the imaging device. The field of view may in particular be a three-dimensional spatial section that is accessible to the imaging device. Specifically, a scene comprised by the field of view may be imaged by the imaging device.

The term “scene” as used herein is a broad term and is to be given its ordinary and customary meaning to a person of ordinary skill in the art and is not to be limited to a special or customized meaning. The term specifically may refer, without limitation, to an optical content of the field of view of the imaging device. Specifically the scene may comprise one or more objects, such as the object mentioned with respect to step i. above, wherein the at least one object in the scene may be imaged by the imaging device. Thus, the scene, specifically, may comprise a plurality of objects, having a specific arrangement, wherein the objects and their arrangement may be imaged by the imaging device, thereby generating at least one image. As part of method step ii., image data of a scene within a field of view of the imaging device is acquired, the scene comprising at least a part of the object and at least a part of the spatial measurement range of the spectrometer device. The object of step i. may at least partially be visible in the image data of step ii. The field of view of the imaging device and the spatial measurement range of the spectrometer device may, thus, at least partially overlap. A spatial relationship between the field of view of the imaging device and the spatial measurement range of the spectrometer device may be known and may be used e.g. in step iii., such as offset between the field of view of the imaging device and the spatial measurement range of the spectrometer device and/or at least one angle between the field of view of the imaging device and the spatial measurement range of the spectrometer device. Thus, a position and/or an object in the field of view of the imaging device may also be located in the spatial measurement range of the spectrometer device, or vice a versa. Specifically the at least one object, or at least a part thereof, may thus be situated in both the field of view of the imaging device and the spatial measurement range of the spectrometer device. The at least one object, or at least a part thereof, may thus be spectroscopically examined by the spectrometer device as well as at least partially be imaged by the imaging device.

The term “image information” as used herein is a broad term and is to be given its ordinary and customary meaning to a person of ordinary skill in the art and is not to be limited to a special or customized meaning. The term specifically may refer, without limitation, to an arbitrary item of information derived from the image data acquired the imaging device. Specifically, step iii. of the method may further comprise deriving the at least one item of image information from the image data of step ii. The item of image information may be or may comprise at least one item of spatial information on the spatial measurement range of the spectrometer device, e.g. information on a location or position of the spatial measurement range within the scene imaged by the imaging device. Additionally or alternatively, the item of image information may be or may comprise at least one item of identification information on the at least one object, specifically identification information on at least one of: a type of the object, specifically identification information on at least one of: a type of the object, a boundary of the object within the scene, a size of the object, an orientation of the object. A large variety of items of image information may be derived from the image data and is outlined in more detail below.

The term “object” as used herein is a broad term and is to be given its ordinary and customary meaning to a person of ordinary skill in the art and is not to be limited to a special or customized meaning. The term specifically may refer, without limitation, to an arbitrary item, such as animate or inanimate item, accessible to being imaged by the imaging device as well as being spectroscopically examined by the spectrometer device. Specifically, the object may be an inhomogeneous object, e.g. an object whose chemical composition may vary within the object such as in a location-dependent manner. Other objects, however, in particular homogeneous objects with only slight or no variations of their chemical composition, are also feasible. The object may specifically be or comprise a food item, such as a fruit or a vegetable, or a body part, such as the skin.

The term “item of object information” as used herein is a broad term and is to be given its ordinary and customary meaning to a person of ordinary skill in the art and is not to be limited to a special or customized meaning. The term specifically may refer, without limitation, to an arbitrary item of information relating to at least one property of the object, such as at least one of a chemical, a physical and a biological property, e.g. a material and/or a composition of the object. The item of object information may specifically be determined by taking into account the spectroscopic data of the object as well as the image data of the object, in particular the at least one item of image information derived from the image data of method step ii. The item of object information may specifically relate to a property that may vary within the object, such that the property may be characteristic for a specific position or spatial range within the object. The property may, however, show no or only slight variations throughout the object. The item of object information may describe the property in a qualitative and/or quantitative manner, e.g. by one or more numerical values. Specifically, the item of object information may comprise chemical information, in particular a chemical composition, of the object. The item of object information may comprise information on the property as well as spatial information on the specific position or spatial range within the object, where the property was measured.

The term “obtaining at least one item of object information” as used herein is a broad term and is to be given its ordinary and customary meaning to a person of ordinary skill in the art and is not to be limited to a special or customized meaning. The term specifically may refer, without limitation, to an arbitrary process of determining the at least one item of object information. Specifically, for determining the item of object information the spectroscopic data of step i. and at least one item of image information derived from the image data of step ii. may be taken into account. In method step iii. the spectroscopic data of step i. and at least one item of image information derived from the image data of step ii. are evaluated for obtaining the at least one item of object information on the at least one object. Specifically, the evaluated spectroscopic data and the evaluated item of image information may be combined or connected, e.g. in a predetermined manner and/or according to a predetermined algorithm, for obtaining the at least one item of object information. Examples will be given below.

The terms “evaluating data” and “evaluating information” as used herein in “evaluating spectroscopic data” and “evaluating image information” is a broad term and is to be given its ordinary and customary meaning to a person of ordinary skill in the art and is not to be limited to a special or customized meaning. The term specifically may refer, without limitation, to an arbitrary process of analyzing the data respectively information, e.g. by applying at least one analysis step, e.g. an analysis step comprising at least one analysis algorithm applied to the data and/or information. Specifically, the data or information may be processed and/or interpreted and/or assessed as part of the analysis step, e.g. by comparing the data or information, or at least a subset thereof, to at least one predetermined value or identifying at least one global or local maximal or minimal value. As an example, the evaluation of the spectroscopic data may comprise analyzing the spectroscopic data to determine at least one peak within the spectroscopic data reflecting a global or local maximum of the transmission, the absorption, the reflection and/or the emission of the object. The evaluation of the spectroscopic data may further comprise identifying the at least one corresponding wavelength. Furthermore, the evaluation of the spectroscopic data may comprise determining the chemical composition of the object, e.g. by comparing the identified peaks to at least one predetermined peak or at least one predetermined set of peaks. The evaluation of the spectroscopic data may specifically be performed using at least one spectroscopic evaluation algorithm. A result of the evaluation of the spectroscopic data may also be referred to as spectroscopic object information. As an example, the evaluation of the item of image information may comprise analyzing the item of image information e.g. using at least one identification algorithm, specifically at least one object recognition algorithm as outlined in more detail further below.

Method step iii. may further comprise deriving the at least one item of image information from the image data of step ii. The expression “deriving image information from image data” as used herein is a broad term and is to be given its ordinary and customary meaning to a person of ordinary skill in the art and is not to be limited to a special or customized meaning. The expression specifically may refer, without limitation, to determining at least one item of image information on the basis of the image data acquired by the imaging device in step ii. Specifically, the at least one item of image information may comprise at least one of:
at least one image derived from the image data of step ii.;
at least one item of spatial information on the spatial measurement range within the scene, specifically an indication of the spatial measurement range at which the spectroscopic data was acquired within an image;
at least one item of identification information on the at least one object, specifically identification information on at least one of: a type of the object, a boundary of the object within the scene, a size of the object, an orientation of the object, a color of the object, a texture of the object, a shape of the object, a contrast of the object, a volume of the object, a region of interest of the object;
at least one item of orientation information on the at least one object, specifically an indication of an orientation of the spectrometer device relative to the at least one object;
at least one item of direction information, specifically an indication of a direction between the spectrometer device and the at least one object;
at least one item of resemblance information on the object, specifically resemblance information on at least one shared property, which is shared between different regions of the object.

The term “image” as used herein is a broad term and is to be given its ordinary and customary meaning to a person of ordinary skill in the art and is not to be limited to a special or customized meaning. The term specifically may refer, without limitation, to an arbitrary representation, e.g. a one-dimensional, two-dimensional or three-dimensional representation, of at least one optically detectable property of the sample. In particular, the image may comprise a graphical representation of the scene within the field of view of the imaging device. The image may specifically be displayed, e.g. on a display device such as a screen of a mobile device, e.g. the mobile device that may comprise the imaging device. The image specifically may comprise the image data mentioned in step ii., or a part thereof, and/or may be derived from the image data or a part thereof. The image may in particular represent at least one visual property of the sample.

Specifically, the at least one item of image information may comprise at least one image derived from the image data of step ii., wherein steps i. and ii. may be performed repeatedly, wherein the at least one item of object information in step iii. may comprise a combination of spectroscopic object information derived from the repetitions of step i. and at least one item of spatial information on the spatial measurement range within the scene derived from the repetitions of step ii. The method may further comprise indicating at least one of the spatial information and the spectroscopic object information in the image. Thus, as an example, the image may contain information on the location of the acquisition of the spectroscopic data and/or the result of the evaluation of the spectroscopic data, e.g. composition information derived from the spectroscopic data. The image, thus, may visually indicate the scene, or a part thereof, as well as information derived from the spectroscopic data acquired in step i., optionally with position information regarding the location of acquisition of the information. Thus, the image may contain an overlap between the at least one object visible in the scene, and one or more locations in which one or more spectroscopic measurements were performed, including, optionally, the results of the spectroscopic measurements and/or one or more items of information derived from the spectroscopic measurements.

Between the possible repetitions of steps i. and ii., at least one of the scene, the field of view and the object may be modified. Thus, as an example, the scene may vary, and/or at least one of the spectrometer device, the imaging device and a device comprising both the spectrometer device and the imaging device, such as a mobile device, as discussed above, may be moved.

Particularly, the method may generate the at least one image of the scene with at least two items of spectroscopic object information and corresponding spatial information on the spatial measurement range within the image for each item of spectroscopic object information. Further, the image derived from the image data of step ii. may be an image derived from the image data of the repetitions of step ii., specifically at least one of a combined image and a selected image of images derived from the image data of the repetitions of step ii.

As an example, as discussed above, the imaging device and/or the spectrometer device may be moved between, specifically during, the optional repetitions of steps i. and ii. Specifically, in an initial performance of step ii. image data of a first scene may be acquired at a first distance, wherein for the repetitions of step ii. the imaging device and/or the spectrometer device may be moved closer to the object such that the imaged scenes are subsections of said first scene. In particular, image data corresponding to a wide image may be acquired in the initial performance of step ii. The wide image may comprise the object fully or almost fully. For the further repetitions of step ii. the distance of the imaging device and/or the spectrometer device to the object may be reduced to at least one second distance, wherein the second distance may allow acquiring spectroscopic data of the object by performing step i. The second distance may be in the range from 0 mm to 100 mm, specifically from 0 mm to 15 mm. The images derived from the image data acquired at the second distance may show subsections of the image derived from the image data acquired in the initial performance of step ii. The method may further comprise tracking a movement of the imaging device, e.g. from the first distance to the at least one second distance, by using the imaging device and a motion tracking software. Specifically, the spatial relation between the image data and/or the spectroscopic data acquired at the at least one second distance with the image acquired at the first distance may be deduced. The item of object information may connect the spectroscopic object information, e.g. the chemical composition as determined using the spectroscopic data, to the item of spatial information identifying in the image the site of the object for which the spectroscopic object information is valid. The site of the object may be identified in the image by at least one graphical indication such as an arrow pointing to the site or by a circle, a square or another type of indication encircling or marking the site. One or several such sites may be marked in the image and the corresponding spectroscopic object information shown.

As a further example, the imaging device and/or the spectrometer device may be moved across the object, such as in a fixed distance and/or in a variable distance, e.g. along a scanning path, while performing one or more repetitions of steps i. and ii. By performing step iii., the at least one item of object information may be obtained, wherein the item of object information may comprise a plurality of items of chemical information corresponding to a plurality of sites along the scanning path. Again, image data of the object may be acquired, e.g. in an initial performance of step ii., wherein the scanning path may be comprised by the image derived from the image data. Specifically, the scanning path and/or the spectroscopic object information, specifically the chemical information, may be indicated in the image. This may allow to retrieve the chemical information along the scanning path.

As a further example, the item of image information may comprise at least one item of identification information on the at least one object, specifically identification information on at least one of: the type of the object, the boundary of the object within the scene, the size of the object, the orientation of the object, a color of the object, a texture of the object, a shape of the object, a contrast of the object, a volume of the object, a region of interest of the object. The item of identification information may in particular be derived by using at least one identification algorithm, such as an image recognition algorithm and/or a trained model configured for recognizing or identifying the object, e.g. by using artificial intelligence, such as an artificial neural network. In particular, the at least one item of image information may comprise the at least one item of identification information on the at least one object, wherein the method comprises applying the at least one identification algorithm to the at least one item of image information for deriving the at least one item of identification information from the at least one item of image information. The identification algorithm may specifically comprise at least one object recognition algorithm for determining the type of the at least one object. For example, the object recognition algorithm may identify the type of the object, e.g. a category or kind of the object such as the object being an apple, an orange or another type of fruit or vegetable, a human body part, such as a hand or a face. Further types of objects are possible, in particular further kinds of food objects. Specifically, step iii. may comprise applying at least one spectroscopic evaluation algorithm to the spectroscopic data of step i., wherein the spectroscopic evaluation algorithm is selected in accordance with the item of identification information, specifically in accordance with the type of the at least one object.

The method may in particular comprise providing a plurality of spectroscopic evaluation algorithms for different items of identification information, specifically for different types of objects. Thus, depending on the type of object as determined by the identification algorithm, a corresponding spectroscopic evaluation algorithms may be chosen such that information determined from the image data may subsequently be used for the evaluation of the spectroscopic data. As an example, the item of image information may comprise the item identification information identifying the object whose spectroscopic data was acquired as being an apple. Accordingly, the spectroscopic data may be evaluated using a spectroscopic evaluation algorithm optimized for the evaluation of apples. Using application-specific spectroscopic evaluation algorithms may increase accuracy of the evaluation result, e.g. the chemical composition of the object, and/or accelerate the evaluation process.

Additionally or alternatively, the item of image information may comprise identification information on the size of the object. Thus, the image information may comprise identification information on both the type and the size of the object. The different items of identification information may be combined and create added value. As an example, the object may be identified as an apple and the size of the apple may be derived from the image data. Based on these items of information an estimated weight of the apple may be determined. To obtain the item of object information, this information may be combined with the chemical composition as determined by evaluating the spectroscopic data to deduce at least one item of nutritional information such as the nutritional values per portion.

The item of image information may comprise identification information, e.g. identification information on at least one region of interest of the object. The region of interest may be identified as such e.g. by the image recognition algorithm and/or the trained model. As an example, the region of interest may be or may comprise an irregularity and/or an unexpected feature. Further regions of interest are possible. The region of interest may e.g. be a mole on a stretch of human skin, such as on a hand or leg. The method may provide a step of providing at least one item of guidance information indicating the region of interest to the user, e.g. on the display of the mobile device. The item of guidance information may in particular prompt the user to perform step i) of the method on the region of interest. Using application-specific spectroscopic evaluation algorithms may provide specific information on the region of interest to the user, e.g. medical information and/or medical guidance e.g. cancer diagnostic information on the mole.

The item of image information may comprise at least one item of resemblance information on the object, specifically resemblance information on at least one shared property, which is shared between different regions of the object. In particular, the item of image information may comprise information on different regions of the object that share at least one common property. The property may be a quality identified in the image data, particularly in the image. The shared property may e.g. a common color that is shared between different regions of the object while further regions of the object show different colors. The shared property identified in the image data, e.g. similar image information, may imply shared and/or similar spectroscopic data, e.g. similar spectral information. The method may comprise predicting spectroscopic data and/or at least spectroscopically derivable property for regions of the object, which resemble each other in at least one property of the image data. The method may further comprise checking and/or refining the prediction, e.g. by guiding the user to acquire spectroscopic data on the further regions with the shared property. As an example, the object may be an apple comprising regions of different colors. As part of the method, the regions sharing a red color may be identified as an item of resemblance information. The spectroscopic data acquired for one of the regions may indicate a particular sugar content, e.g. a sugar content that exceeds the sugar content of further regions of different color, e.g. of green color. As part of the method, the sugar content of the further red regions may be predicted. Further, the user may be guided to acquire spectroscopic data on the further red regions to check and/or refine the prediction and/or possible further predictions.

Step iii) of the method may further comprise taking into account information of at least one further sensor in obtaining the at least one item of object information. The further sensor information may e.g. comprise gyroscopic information and/or GPS information. The further sensor, specifically the gyroscope may be part of the mobile device. Additionally or alternatively, the further sensor information may be provided by the mobile device, e.g. the GPS information. The further sensor information may e.g. be taken into account by checking, verifying or assessing the item of image information.

The method may be at least partially computer-implemented, specifically step iii. The computer-implemented steps and/or aspects of the invention, may particularly be performed by using a computer or computer network. As an example, step iii. of the method may be fully or partially computer-implemented. Thus, the evaluation of the spectroscopic data may specifically be performed using at least one spectroscopic evaluation algorithm. The evaluation of the item of image information may comprise analyzing the item of image information e.g. using at least one identification algorithm. The evaluated spectroscopic data and the evaluated item of image information may be combined or connected, e.g. in a predetermined manner and/or according to a predetermined algorithm, for obtaining the at least one item of object information. The at least one spectroscopic evaluation algorithm may in particular comprise at least one trained model. The term “trained model” as used herein is a broad term and is to be given its ordinary and customary meaning to a person of ordinary skill in the art and is not to be limited to a special or customized meaning. The term specifically may refer, without limitation, to a mathematical model which was trained on at least one training data set using one or more of machine learning, deep learning, neural networks, or other form of artificial intelligence.

The method may further comprise providing the at least one item of object information on the at least one object, specifically optically providing the at least one item of object information on the at least one object via a display device. Specifically, the item of object information may be displayed e.g. on a display device such as a screen of a mobile device, e.g. the mobile device that may comprise the imaging device and/or the spectrometer device.

In a further aspect of the present invention, a system for obtaining at least one item of object information on at least one object by spectroscopic measurement is disclosed. The system comprises:
I. at least one spectrometer device configured for acquiring spectroscopic data within at least one spatial measurement range of the spectrometer device;
II. at least one imaging device, specifically a camera, configured for acquiring image data of a scene within a field of view of the imaging device, the scene comprising at least a part of the object and at least a part of the spatial measurement range of the spectrometer device; and
III. at least one evaluation unit configured for evaluating the spectroscopic data acquired by the spectrometer device and at least one item of image information derived from the image data acquired by the imaging device, for obtaining the at least one item of object information on the at least one object.

The system for obtaining at least one item of object information may specifically be used for performing the method of obtaining at least one item of object information according to the present invention, such as according to any one of the embodiments described above and/or according to any one of the embodiments described further below. Accordingly, regarding terms and definitions, reference may be made to the description of the method of obtaining at least one item of object information as given above.

The term “system” as used herein is a broad term and is to be given its ordinary and customary meaning to a person of ordinary skill in the art and is not to be limited to a special or customized meaning. The term specifically may refer, without limitation, to a set or an assembly of interacting components, which may interact to fulfill at least one common function. The at least two components may be handled independently or may be coupled or connectable.

The term “evaluation unit” as used herein is a broad term and is to be given its ordinary and customary meaning to a person of ordinary skill in the art and is not to be limited to a special or customized meaning. The term specifically may refer, without limitation, to an arbitrary functional element configured for analyzing and/or processing data. The evaluation unit may specifically be configured for analyzing spectroscopic data and/or image data, specifically the item of image information. The evaluation unit may specifically process and/or interpret and/or assess the data and/or information as part of the analysis process. The evaluation unit may in particular comprise at least one processor. The processor may specifically be configured, such as by software programming, for performing one or more evaluation operations on the data and/or information. The term “processor”, also referred to as a “processing unit”, as generally used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processing unit may be configured for processing basic instructions that drive the computer or system. As an example, the processing unit may comprise at least one arithmetic logic unit (ALU), at least one floating-point unit (FPU), such as a math co-processor or a numeric coprocessor, a plurality of registers, specifically registers configured for supplying operands to the ALU and storing results of operations, and a memory, such as an L1 and L2 cache memory. In particular, the processing unit may be a multi-core processor. Specifically, the processing unit may be or may comprise a central processing unit (CPU). Additionally or alternatively, the processing unit may be or may comprise a microprocessor, thus specifically the processing unit's elements may be contained in one single integrated circuitry (IC) chip. Additionally or alternatively, the processing unit may be or may comprise one or more application-specific integrated circuits (ASICs) and/or one or more field-programmable gate arrays (FPGAs) or the like. The processing unit specifically may be configured, such as by software programming, for performing one or more evaluation operations.

The imaging device may comprise at least one camera having one or more imaging sensors, specifically one or more CCD or CMOS imaging sensors, for acquiring the image data of the scene. The imaging device may specifically comprise a one-dimensional or two-dimensional array of imaging sensors, such as pixels, which may e.g. be arranged on the camera chip. Additionally or alternatively, the imaging device may comprise be or may comprise at least one LIDAR-based imaging device. The LIDAR-based imaging device may comprise at least one laser source for illuminating the object and at least one localization unit. The localization unit may comprise at least one sensor element configured for detecting at least one laser beam emitted from the laser source and reflected by the object. The localization unit may be configured for determining at least one distance of the illuminated part of the object from at least one reference point. Determination of the distance, and thus generation of the image data may comprise processing the light beam reflected by the object and/or at least one reference light beam and/or the corresponding signals detected by the at least one sensor element. For further options and/or optional details, reference may be made to the description of the imaging device given above.

The spectrometer device may comprise at least one detector device comprising at least one optical element and a plurality of photosensitive elements, wherein the at least one optical element is configured for separating incident light into a spectrum of constituent wavelength components, wherein each photosensitive element is configured for receiving at least a portion of one of the constituent wavelength components and for generating a respective detector signal depending on an illumination of the respective photosensitive element by the at least one portion of the respective constituent wavelength component. Thus, the spectrometer device may analyze incident light after its interaction with the object and generate at least one corresponding detector signal, which may form part of the spectroscopic data. The optical element may comprise at least one wavelength-selective element. The wavelength-selective element may specifically be selected form the group consisting of: a prism; a grating; a linear variable filter; an optical filter, specifically a narrow band pass filter. The detector device may further comprise the plurality of photosensitive elements arranged in a linear array, wherein the array of photosensitive elements comprises a number of 10 to 1000, specifically a number of 100 to 500, specifically a number of 200 to 300, more specifically a number of 256, photosensitive elements. Each photosensitive element may in particular be selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising Si, PbS, PbSe, Ge, InGaAs, ext. InGaAs, InSb or HgCdTe. Each photosensitive element may be sensitive for electromagnetic radiation in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm. The spectrometer device may be or may comprise a dispersive spectrometer device that may analyze the radiation of an object illuminated with a broadband illumination, e.g. as described above. However, further configurations and/or arrangements of the spectrometer device are feasible which may in particular affect its components e.g. the detector and/or a source of illumination used. As an example, the object may be illuminated with light of a limited number of different wavelengths. The spectrometer device may comprise a broadband detector. In particular, the spectrometer device may be a Fourier-Transform spectrometer, specifically a Fourier-Transform infrared spectrometer. Thus, narrow-band light sources may be used, such as at least one light emitting diode (LED) and/or at least one laser, for illuminating the object. Specifically, the spectrometer device may be configured for determining the spectrum by measuring and processing an interferogram, particularly by applying at least one Fourier transformation to the measured interferogram.

The spectrometer device and the imaging device may have a known orientation with respect to each other, specifically a fixed orientation. In particular, the spectrometer device and the imaging device may have a known, specifically a fixed spatial relation with respect to each other. Further, the spatial measurement range of the spectrometer device and the field of view of the imaging device may have a fixed spatial relation with respect to each other.

The system may further comprise at least one light source configured for emitting electromagnetic radiation in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm. The spectrometer device may in particular be referred to as a “near-infrared spectrometer device”.

The evaluation unit of the system is configured for obtaining the at least one item of object information on the at least one object. The system may comprise at least one display device configured for providing the at least one item of object information on the at least one object. The system may further comprise at least one mobile device, wherein the mobile device comprises the at least one spectrometer device and the at least one imaging device. Thus, the spectrometer device and the imaging device, such as the at least one camera, may both be integrated into the mobile device, such as into a smart phone. The term “mobile device” as used herein is a broad term and is to be given its ordinary and customary meaning to a person of ordinary skill in the art and is not to be limited to a special or customized meaning. The term specifically may refer, without limitation, to a mobile electronics device, more specifically to a mobile communication device such as a cell phone or smart phone. Additionally or alternatively, the mobile device may also refer to a tablet computer or another type of portable computer having at least one camera. The mobile device may particularly have at least one display device, specifically a screen, configured for displaying the item of object information.

The system may further comprise at least one control unit. The term “control unit” as used herein is a broad term and is to be given its ordinary and customary meaning to a person of ordinary skill in the art and is not to be limited to a special or customized meaning. The term specifically may refer, without limitation, to a device or combination of devices capable and/or configured for performing at least one computing operation and/or for controlling at least one function of at least one other device, such as of at least one other component of the system for obtaining at least one item of object information. The control unit may specifically control at least one function of the spectrometer device, e.g. the acquiring of spectroscopic data. The control unit may specifically control at least one function of the imaging device, e.g. the acquiring of image data. The control unit may specifically control the evaluation unit, e.g. the evaluation of the spectroscopic data and/or the at least one item of image information. Specifically, the at least one control unit may be embodied as at least one processor and/or may comprise at least one processor, wherein the processor may be configured, specifically by software programming, for performing one or more operations. The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for controlling and/or performing one or more evaluation operations.

In a further aspect, a computer program is disclosed. The computer program comprises instructions which, when the program is executed by a control unit of the system as disclosed herein, such as according to any one of the embodiments described above and/or according to any one of the embodiments described in further detail below, cause the system to perform the method as disclosed herein, such as according to any one of the embodiments described above and/or according to any one of the embodiments described in further detail below. Thus, as an example, the computer program may cause the system or trigger the system to acquire spectroscopic data by using the spectrometer device in accordance with step i., may cause or trigger the system to acquire, by using the imaging device, image data of the scene according to step ii., and may provide instructions for the system to perform the evaluation, in accordance with step iii. The computer program may in particular comprise instructions, which cause the system to perform step iii. of the method. The computer program may further comprise instructions, which cause the system to perform step i. and step ii. of the method, on its own motion or in response to at least one user action, which may e.g. initiate the acquiring of spectroscopic data in step i. and/or the acquiring of image data in step ii., such as a user interaction like pushing a start button. The computer program may also comprise instructions that cause or trigger the system to prompt the user to provide a specific input. Thus, as an example, the user may be prompted to start the acquisition of the spectroscopic data in step i. and/or may be prompted to start the acquisition of the image data in step ii.

In a further aspect, a computer-readable storage medium is disclosed, comprising instructions which, when the instructions are executed by the control unit of the portable spectrometer device as disclosed herein, such as according to any one of the embodiments described above and/or according to any one of the embodiments described in further detail below, cause the control unit to perform the method as disclosed herein, such as according to any one of the embodiments described above and/or according to any one of the embodiments described in further detail below. As used herein, the term “computer-readable storage medium” specifically may refer to a non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

The method of obtaining at least one item of object information and the system for obtaining at least one item of object information as disclosed herein provide a large number of advantages over known devices and methods of similar kind. Specifically, the above-mentioned technical challenges are addressed. By combining a spectrometer device with an imaging device spatially resolved spectroscopic data may be acquired. This may allow obtaining chemical information at different, accurately traced positions on the object. Specifically, the method and the system provided may allow obtaining accurate spectroscopic data of an object despite possible local variations of its chemical composition, as is the case for inhomogeneous objects.

Specifically, the proposed method, system, computer program and computer-readable storage medium may facilitate correlating a spectral axis with a spatial position at which the spectroscopic data, particularly a spectrum, also referred to as spectral curve, was obtained. The system may specifically be embodied as comprising a sensor fusion of a spectrometer device with an imaging device, particularly with imaging optics and/or an imaging detector. This may in particular allow capturing of spatially resolved spectroscopic data given a device such as a smartphone with an imaging device, specifically a visual camera, and a spectrometer device, e.g. an NIR spectrometric sensor. Using data obtained in this way may enable to obtain chemical information at different, accurately traced positions on the object, e.g. the sample.

The imaging device, specifically the camera, may be used to track a current pointing and orientation of the spectrometer device enabling a spatial correlation of the spectroscopic data, specifically the spectrum, that is taken at any point in time. In particular, the user may take a wide image using the imaging device and then approach individual elements seen in the wide image at close distance such that the spectrometer device can obtain the spectroscopic data, specifically the spectrum, of a specific patch. During the movement of the system, the position within the image, e.g. the wide image, which may also be referred to as the original image, may be actively tracked using the imaging device, specifically the camera, and a motion tracking software. By repeating this procedure several times on different spots in the original image, spectral information of different patches may be obtained. By further using a trained model either directly on the evaluation unit of the system or on a computing cloud, the chemical composition at each individual spot may be determined and provided to the user.

An alternative application of the proposed method, system, computer program and computer-readable storage medium may be a drift-scan technique that allows the user to move across the object, e.g. the sample, whilst in parallel acquiring image data, specifically taking images, and spectroscopic data. Combined in a mosaic, the spectroscopic data, specifically the spectra, and the images may allow to retrieve chemical information along a scanning path.

Summarizing and without excluding further possible embodiments, the following embodiments may be envisaged:

Embodiment 1: A method of obtaining at least one item of object information on at least one object by spectroscopic measurement, the method comprising:
i. acquiring spectroscopic data, specifically of the object, by using at least one spectrometer device, within at least one spatial measurement range of the spectrometer device;
ii. acquiring, by using at least one imaging device, specifically a camera, image data of a scene within a field of view of the imaging device, the scene comprising at least a part of the object and at least a part of the spatial measurement range of the spectrometer device; and
iii. evaluating the spectroscopic data of step i. and at least one item of image information derived from the image data of step ii., for obtaining the at least one item of object information on the at least one object.

Embodiment 2: The method according to the preceding claim, wherein step iii. further comprises deriving the at least one item of image information from the image data of step ii.

Embodiment 3: The method according to any one of the preceding claims, wherein the at least one item of image information comprises at least one of:
at least one image derived from the image data of step ii.;
at least one item of spatial information on the spatial measurement range within the scene, specifically an indication of the spatial measurement range at which the spectroscopic data was acquired within an image;
at least one item of identification information on the at least one object, specifically identification information on at least one of: a type of the object, a boundary of the object within the scene, a size of the object, an orientation of the object, a color of the object, a texture of the object, a shape of the object, a contrast of the object, a volume of the object, a region of interest of the object;
at least one item of orientation information on the at least one object, specifically an indication of an orientation of the spectrometer device relative to the at least one object;
at least one item of direction information, specifically an indication of a direction between the spectrometer device and the at least one object;
at least one item of resemblance information on the object, specifically resemblance information on at least one shared property, which is shared between different regions of the object.

Embodiment 4: The method according to any one of the preceding claims, wherein the at least one item of image information comprises at least one image derived from the image data of step ii., wherein steps i. and ii. are performed repeatedly, wherein the at least one item of object information in step iii. comprises a combination of spectroscopic object information derived from the repetitions of step i. and at least one item of spatial information on the spatial measurement range within the scene derived from the repetitions of step ii., wherein the method comprises indicating at least one of the spatial information and the spectroscopic object information in the image.

Embodiment 5: The method according to the preceding claim, wherein, between the repetitions of steps i. and ii., at least one of the scene, the field of view and the object is modified.

Embodiment 6: The method according to any one of the two preceding claims, wherein the method generates the at least one image of the scene with at least two items of spectroscopic object information and corresponding spatial information on the spatial measurement range, specifically on a position of the spatial measurement range, within the image for each item of spectroscopic object information.

Embodiment 7: The method according to any one of the three preceding claims, wherein the image derived from the image data of step ii. is an image derived from the image data of the repetitions of step ii., specifically at least one of a combined image and a selected image of images derived from the image data of the repetitions of step ii.

Embodiment 8: The method according to any one of the preceding claims, wherein the at least one item of image information comprises at least one item of identification information on the at least one object, wherein the method comprises applying at least one identification algorithm to the at least one item of image information for deriving the at least one item of identification information from the at least one item of image information.

Embodiment 9: The method according to the preceding claim, wherein the identification algorithm comprises at least one object recognition algorithm for determining the type of the at least one object.

Embodiment 10: The method according to any one of the two preceding claims, wherein step iii. comprises applying at least one spectroscopic evaluation algorithm to the spectroscopic data of step i., wherein the spectroscopic evaluation algorithm is selected in accordance with the item of identification information, specifically in accordance with the type of the at least one object.

Embodiment 11: The method according to the preceding claim, wherein the method comprises providing a plurality of spectroscopic evaluation algorithms for different items of identification information, specifically for different types of objects.

Embodiment 12: The method according to any one of the preceding claims, wherein the at least one spectroscopic evaluation algorithm comprises at least one trained model.

Embodiment 13: The method according to any one of the preceding claims, wherein the method further comprises providing the at least one item of object information on the at least one object, specifically optically providing the at least one item of object information on the at least one object via a display device.

Embodiment 14: The method according to any one of the preceding claims, wherein the method is at least partially computer-implemented, specifically step iii.

Embodiment 15: A system for obtaining at least one item of object information on at least one object by spectroscopic measurement, the system comprising:
I. at least one spectrometer device configured for acquiring spectroscopic data, specifically of the object, within at least one spatial measurement range of the spectrometer device;
II. at least one imaging device, specifically a camera, configured for acquiring image data of a scene within a field of view of the imaging device, the scene comprising at least a part of the object and at least a part of the spatial measurement range of the spectrometer device; and
III. at least one evaluation unit configured for evaluating the spectroscopic data acquired by the spectrometer device and at least one item of image information derived from the image data acquired by the imaging device, for obtaining the at least one item of object information on the at least one object.

Embodiment 16: The system according to the preceding claim, wherein the imaging device comprises at least one camera having one or more imaging sensors, specifically one or more CCD or CMOS imaging sensors, for acquiring the image data of the scene.

Embodiment 17: The system according to any one of the preceding claims referring to a system, wherein the imaging device comprises at least one LIDAR-based imaging device for acquiring the image data of the scene.

Embodiment 18: The system according to any one of the preceding claims referring to a system, wherein the spectrometer device comprises at least one detector device comprising at least one optical element and a plurality of photosensitive elements, wherein the at least one optical element is configured for separating incident light into a spectrum of constituent wavelength components, wherein each photosensitive element is configured for receiving at least a portion of one of the constituent wavelength components and for generating a respective detector signal depending on an illumination of the respective photosensitive element by the at least one portion of the respective constituent wavelength component.

Embodiment 19: The system according to the preceding claim, wherein the optical element comprises at least one wavelength-selective element.

Embodiment 20: The system according to the preceding claim, wherein the wavelength-selective element is selected form the group consisting of: a prism; a grating; a linear variable filter; an optical filter, specifically a narrow band pass filter.

Embodiment 21: The system according to any one of the three preceding claims, wherein the detector device comprises the plurality of photosensitive elements arranged in a linear array, wherein the array of photosensitive elements comprises a number of 10 to 1000, specifically a number of 100 to 500, specifically a number of 200 to 300, more specifically a number of 256, photosensitive elements.

Embodiment 22: The system according to any one of the four preceding claims, wherein each photosensitive element is selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising Si, PbS, PbSe, Ge, InGaAs, ext. InGaAs, InSb or HgCdTe.

Embodiment 23: The system according to any one of the five preceding claims, wherein each photosensitive element is sensitive for electromagnetic radiation in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

Embodiment 24: The system according to any one of the preceding claims referring to a system, wherein the spectrometer device and the imaging device have a known orientation with respect to each other, specifically a fixed orientation.

Embodiment 25: The system according to any one of the preceding claims referring to a system, further comprising at least one light source configured for emitting electromagnetic radiation in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm.

Embodiment 26: The system according to any one of the preceding claims referring to a system, further comprising at least one display device configured for providing the at least one item of object information on the at least one object.

Embodiment 27: The system according to any one of the preceding claims referring to a system, wherein the system comprises at least one mobile device, wherein the mobile device comprises the at least one spectrometer device and the at least one imaging device.

Embodiment 28: A computer program comprising instructions which, when the program is executed by a control unit of the system according to any one of the preceding claims referring to a system, cause the system to perform the method according to any one of the preceding claims referring to a method.

Embodiment 29: A computer-readable storage medium comprising instructions which, when the program is executed by a control unit of the system according to any one of the preceding claims referring to a system, cause the system to perform the method according to any one of the preceding claims referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a flow chart of an embodiment of the method of obtaining at least one item of object information;

FIGS. 2A and 2B show a schematic view of a system for obtaining at least one item of object information on an object (FIG. 2A) and said object together with corresponding items of object information (FIG. 2B); and

FIG. 3 shows a further object together with a corresponding item of object information.

### DETAILED DESCRIPTION OF THE EMBODIMENTS

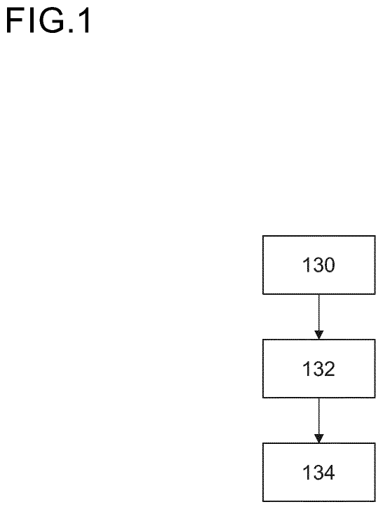

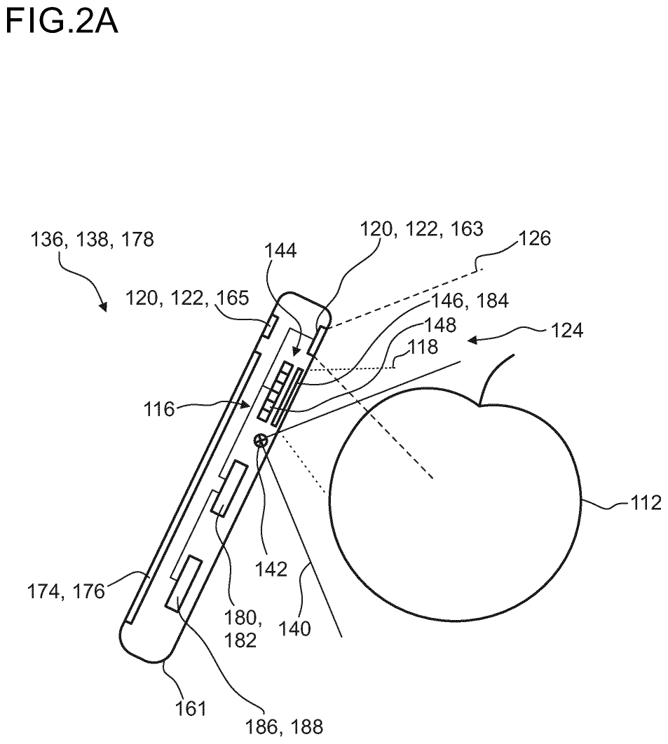

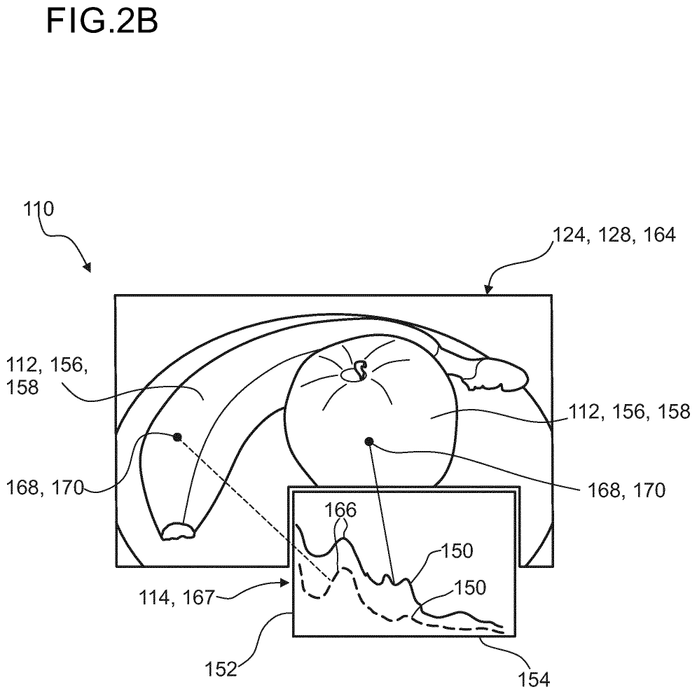

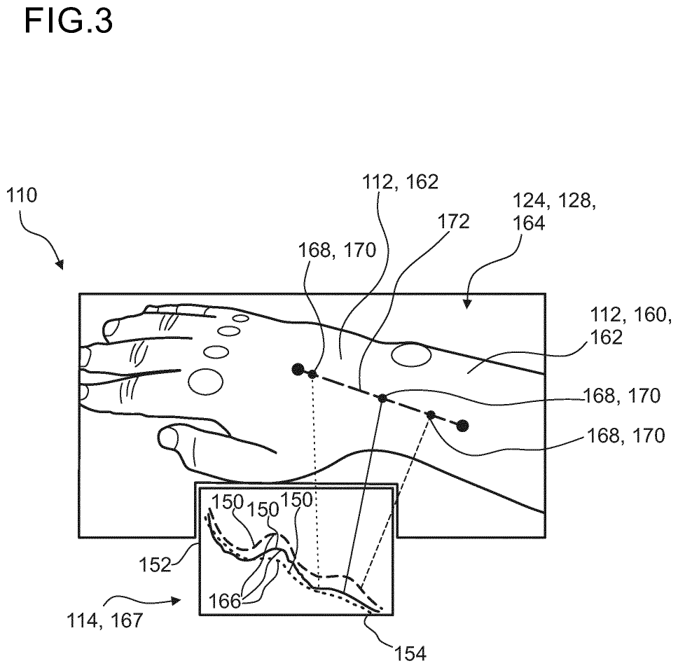

FIG. 1 shows an embodiment of the method of obtaining at least one item of object information 110. In FIG. 2A, an exemplary embodiment of a system 178 for obtaining the at least one item of object information 110 on at least one object 112 by spectroscopic measurement is depicted in a schematic fashion. Examples of possible items of object information 110 as obtained by using the method are illustrated together with corresponding objects 112 in FIG. 2B and in FIG. 3. In the following, these Figures will be described in conjunction.

The system 178 as depicted in FIG. 2A comprises:
I. at least one spectrometer device 116 configured for acquiring spectroscopic data 114 within at least one spatial measurement range 118 of the spectrometer device 116;
II. at least one imaging device 120, specifically a camera 122, configured for acquiring image data of a scene 124 within a field of view 126 of the imaging device 120, the scene 124 comprising at least a part of the object 112 and at least a part of the spatial measurement range 118 of the spectrometer device 116; and
III. at least one evaluation unit 180 configured for evaluating the spectroscopic data 114 acquired by the spectrometer device 116 and at least one item of image information 128 derived from the image data acquired by the imaging device 120, for obtaining the at least one item of object information 110 on the at least one object 112.

As outlined above, in FIG. 1, an exemplary embodiment of the method of obtaining at least one item of object information 110 on at least one object 112 by spectroscopic measurement is shown as a schematic flow chart. The method specifically may make use of the system 178 in FIG. 2A. However, the use of alternative systems is generally also possible. The method comprises the method steps i., ii. and iii., which are described in detail below. In the flow chart of FIG. 1, method step i. is denoted by reference number 130, method step ii. is denoted by reference number 132 and method step iii. is denoted by reference number 134.

The method comprises:
i. acquiring spectroscopic data 114 by using at least one spectrometer device 116, within at least one spatial measurement range 118 of the spectrometer device 116;
ii. acquiring, by using at least one imaging device 120, specifically a camera 122, image data of a scene 124 within a field of view 126 of the imaging device 120, the scene 124 comprising at least a part of the object 112 and at least a part of the spatial measurement range 118 of the spectrometer device 116; and
iii. evaluating the spectroscopic data 114 of step i. and at least one item of image information 128 derived from the image data of step ii., for obtaining the at least one item of object information 110 on the at least one object 112.

The method steps may specifically be performed in the given order. A different order, however, is also feasible. Further, as will be outlined in further detail below, one or more of the method steps or even all of the method steps may be performed repeatedly. Further, the method may comprise additional method steps, which are not listed here.

Step i. of the method comprises acquiring spectroscopic data 114 by using the spectrometer device 116, within the spatial measurement range 118 of the spectrometer device 116. This step will be described herein in conjunction with the specific embodiment of the system 178 shown in FIG. 2A.

Thus, the spectrometer device 116 may specifically be embodied as a portable spectrometer device 116. Specifically, the spectrometer device 116 may be part of a mobile device 136 such as a notebook computer, a tablet or, specifically, a cell phone such as a smart phone 138. The mobile device 136, specifically may have at least one function different from the spectroscopic function, such as a mobile communication function, e.g., the function of a cell phone. The spectrometer device 116 may be at least one of integrated into the mobile device 136 or attachable thereto. The mobile device 136 as shown in FIG. 2A specifically may be embodied as a smart phone 138, with the spectrometer device 116 integrated therein. The spectrometer device 116 may be configured for acquiring the spectroscopic data 114 of the object 112 as part of the spectroscopic measurement. As part of the spectroscopic measurement, the object 112 may be illuminated with electromagnetic radiation 140, specifically light 140 in the infrared spectral range, specifically in the near infrared spectral range. In particular, the electromagnetic radiation 140 may be in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm. The light 140 may specifically be generated by a light source 142 configured for emitting electromagnetic radiation 140 in a wavelength range from 760 nm to 1000 μm, specifically in a wavelength range from 760 nm to 15 μm, more specifically in a wavelength range from 1 μm to 5 μm, more specifically in a wavelength range from 1 μm to 3 μm. The light source 142 may be part of the mobile device 136, specifically the smart phone 138 as shown in FIG. 2A. Other options, however, are also feasible, such as the use of one or more external light sources or embodiments without any light sources.

The spectroscopic measurement may further comprise receiving incident light 140, specifically after interaction with the object 112, and generating at least one corresponding signal, which may form part of the spectroscopic data 114. The spectrometer device 116 as used in step i. may in particular be a near-infrared spectrometer device 116. Thus, the spectrometer device 116 may specifically be configured for detecting electromagnetic radiation 140 in the near-infrared range. The spectrometer device 116 may be configured for performing at least one spectroscopic measurement on the object 112. The spectrometer device 116 may in particular comprise at least one detector device 144 comprising at least one optical element 146 and a plurality of photosensitive elements 148 as illustrated in FIG. 2A, such as an array of semiconducting photosensitive elements 148. The at least one optical element 146 may specifically be configured for separating incident light 140, specifically electromagnetic radiation 140 in the near-infrared range, into a spectrum of constituent wavelength components. Thus, as an example, the at least one optical element 146 specifically may comprise at least one wavelength-selective element 184, such as at least one of a grating, a prism and a filter, such as a length-variable filter having differing regions with differing wavelength-selective transmissions. Thus, as an example, the detector device 144 specifically may comprise an array, such as a linear array, of photosensitive elements 148, the photosensitive elements 148 being combined with different filters or filter regions of the length-variable filter having different spectral properties, such that each combination of a photosensitive element 148 with its corresponding filter or filter region is sensitive in a different spectral range. Thus, each photosensitive element 148 may be configured, specifically in conjunction with the wavelength-selective element 184, for receiving at least a portion of one of the constituent wavelength components and for generating a respective detector signal depending on an illumination of the respective photosensitive element 148 by the at least one portion of the respective constituent wavelength component. The detector signal, specifically the signal intensity, may together with the corresponding wavelength form part of the spectroscopic data 114, wherein the detector signal may be part of the spectroscopic data 114.

The spectroscopic data 114 may comprise information on at least one optical property or optically measurable property of the object 112, which is determined as a function of the wavelength, for one or more different wavelengths. More specifically, the spectroscopic data 114 may relate to at least one property characterizing at least one of a transmission, an absorption, a reflection and an emission of the object 112. The at least one optical property, may be determined for one or more wavelengths. The spectroscopic data 114 may specifically take the form of a signal intensity determined as a function of the wavelength of the spectrum or a partition thereof, such as a wavelength interval, wherein the signal intensity may preferably be provided as an electrical signal, which may be used for further evaluation. Specifically, the spectroscopic data 114 may be graphically represented in the form of a spectral curve 150, wherein the signal intensity I plotted on the y-axis 152 is shown as a function of wavelength λ plotted on the x-axis 154, as depicted in FIG. 2B and FIG. 3. Specifically, the signal intensity I may correspond to an intensity of reflected electromagnetic radiation 140, e.g. of electromagnetic radiation 140 in the infrared spectral range, with which the object 112, or at least a part of the object 112, may be illuminated, such as with the light source 142 of the smart phone 138 as illustrated in FIG. 2A. The spectral curve 150 may show the reflected intensity I as a function of the wavelength λ, as depicted in FIG. 2B and FIG. 3.

In step i. the spectroscopic data 114 are acquired by using the at least one spectrometer device 116, within the spatial measurement range 118 of the spectrometer device 116. Specifically, the spectrometer device 116 may be configured to acquire spectroscopic data 114 on the basis of incident light 140 from within the spatial measurement range 118. As illustrated in FIG. 2A, the spatial measurement range 118 may in particular be a three-dimensional spatial section, e.g. a three-dimensional space, such as a cone-shaped spatial section, whose light content may be received and analyzed by the spectrometer device 116. As an example, the spatial measurement range 118 may be defined as a solid angle or three-dimensional angular segment in space, wherein objects 112 disposed within the solid angle or angular segment may be analyzed by the spectrometer device 116. A solid angle or angular segment, as an example, may be defined by geometric and/or optical properties of the spectrometer device 116. The spectroscopic data 114 acquired by the spectrometer device 116 may comprise information relating to the at least one object 112 when the object 112 is situated within the spatial measurement range 118 of the spectrometer device 116. Specifically, for spectroscopically analyzing the object 112, the spectrometer device 116 may be scanned over a range comprising the object, or may be positioned in close proximity to the object 112, e.g. at a distance in the range from 0 mm to 100 mm from the object 112, specifically in the range from 0 mm to 15 mm. In the exemplary embodiment of step i. shown in FIG. 2A the object 112 positioned in the spatial measurement range 118 of the spectrometer device 116 may be or may comprise an apple. A large variety of objects 112, however, is feasible. Thus, the object 112 may generally be an arbitrary animate or inanimate item. Specifically, the object 112 may be an inhomogeneous object 112, e.g. an object 112 with at least one property, e.g. at least one of a chemical, a physical and a biological property, that varies within the object 112 such as in a location-dependent manner. Particularly, the chemical composition may vary within the object 112 in a location-dependent manner. Other objects 112, however, in particular homogeneous objects 112, e.g. objects 112 with only slight or no variations of their chemical composition, are also feasible. The object 112 may specifically be or comprise a food item 156, such as a fruit 158 or a vegetable, or a body part 160, such as the skin 162. Objects 112 illustrated in an exemplary fashion in the Figures are an apple in FIGS. 2A and 2B, a banana in FIG. 2B and the skin 162 of a human hand and arm in FIG. 3.

In step ii. of the method as depicted in FIG. 1, image data of a scene 124 within the field of view 126 of the imaging device 120 are acquired by using the imaging device 120. The imaging device 120, as outlined above, may be or may comprise at least one camera 122, having one or more imaging sensors, specifically one or more CCD or CMOS imaging sensors, for acquiring the image data. The camera 122 may specifically comprise at least one camera chip, such as at least one CCD chip and/or at least one CMOS chip configured for recording images 164. The camera 122 may comprise a one-dimensional or two-dimensional array of imaging sensors, such as pixels, which may e.g. be arranged on the camera chip. As an example, the camera 122 may comprise at least 100 pixels in at least one dimension, such as at least 100 pixels in each dimension. As an example, the camera 122 may comprise an array of imaging sensors comprising at least 100 imaging sensors in each dimension, specifically at least 300 imaging sensors in each dimension. For example, the camera 122 may be a color camera 122, comprising color pixels, wherein each color pixel comprises at least three color sub-pixels sensitive for different colors. For example, the camera 122 may comprise black and white pixels and/or color pixels. The color pixels and the black and white pixels may be combined internally in the camera 122. The camera 122 may be a camera 122 of a mobile device 136. The invention specifically shall be applicable to cameras 122 as usually used in mobile devices 136 such as notebook computers, tablets or, specifically, cell phones such as smart phones 138. FIG. 2A shows such a smart phone 138 comprising a camera 122 as imaging device 120. The mobile device 136, specifically the smart phone 138, may further comprise one or more data processing devices such as one or more processors 188 as shown in FIG. 2A. The camera 122, besides the at least one camera chip or imaging chip, may comprise further elements, such as one or more optical elements, e.g. one or more lenses (not shown). As an example, the camera 122 may be a fix-focus camera 122, having at least one lens, which is fixedly adjusted with respect to the camera 122. Alternatively, however, the camera 122 may also comprise one or more variable lenses, which may be adjusted, automatically or manually.

As illustrated in FIG. 2A, the mobile device 136, specifically the smart phone 138, may comprise both the camera 122 and the spectrometer device 116. Thus, the spectrometer device 116 and the imaging device 120, such as the at least one camera 122, may both be integrated into the mobile device 136, such as into the smart phone 138. The smart phone 138 may further comprise a housing 161, wherein the spectrometer device 116 and the imaging device 120, specifically the camera 122, may be integrally contained within the housing 161. The smart phone 138 may specifically comprise a front camera 163 and a rear camera 165. In particular, the field of view 126 of the front camera 163 may at least partially overlap with the spatial measurement range 118 of the spectrometer device 116 as illustrated in FIG. 2A. Specifically, for performing method step ii. the front camera 163 may be used. Other possibilities are feasible.

In step ii., the image data of the scene 124 within the field of view 126 of the imaging device 120 are acquired, the scene 124 comprising at least the part of the object 112 and at least the part of the spatial measurement range 118 of the spectrometer device 116. FIG. 2A indicates both the field of view 126 of the imaging device 126 and the spatial measurement range 118 of the spectrometer device 116. The image data generated by the imaging device 120 may comprise spatially resolved optical information relating to the object 112 located within the field of view 126 of the imaging device 120. The field of view 126 may in particular be a three-dimensional spatial section whose optical content may be imaged by the imaging device 120. Specifically, the scene 124 comprised by the field of view 126 may be imaged by the imaging device 120. Specifically the scene 124 may comprise one or more objects 112, such as the object 112 mentioned with respect to step i. above, wherein the at least one object 112 in the scene 124 may be imaged by the imaging device 120. Thus, the scene 124, specifically, may comprise a plurality of objects 112, having a specific arrangement, wherein the objects 112 and their arrangement may be imaged by the imaging device 120, thereby generating the at least one image 164. As an example, the image 164 in FIG. 2B shows a scene 124 comprising an apple and a banana arranged on a plate situated on a substrate, wherein the apple and the banana may serve as objects 112, on which spectroscopic data 114 are acquired. In the exemplary embodiment illustrated in 2A, the scene 124 comprises an upper part of the apple. The scene 124 further comprises at least a part of the spatial measurement range 118 of the spectrometer device 116 as depicted in FIG. 2A. Thus, the field of view 126 of the imaging device 120 and the spatial measurement range 118 of the spectrometer device 116 may at least partially overlap as shown in FIG. 2A.

As part of method step ii., image data of a scene 124 within a field of view 126 of the imaging device 120 are acquired, the scene 124 comprising at least a part of the object 112 and at least a part of the spatial measurement range 118 of the spectrometer device 116. The object 112 of step i. may at least partially be visible in the image data of step ii. The field of view 126 of the imaging device 120 and the spatial measurement range 118 of the spectrometer device 116 may, thus, at least partially overlap. A spatial relationship between the field of view 126 of the imaging device 120 and the spatial measurement range 118 of the spectrometer device 116 may be known and may be used e.g. in step iii., such as offset between the field of view 126 of the imaging device 120 and the spatial measurement range 118 of the spectrometer device 116 and/or at least one angle between the field of view 126 of the imaging device 120 and the spatial measurement range 118 of the spectrometer device 116. Thus, a position and/or an object 112 in the field of view 126 of the imaging device 120 may also be located in the spatial measurement range 118 of the spectrometer device 116, or vice a versa. Specifically the at least one object 112, or at least a part thereof, may thus be situated in both the field of view 126 of the imaging device 120 and the spatial measurement range 118 of the spectrometer device 116 as apparent from FIG. 2A. The at least one object 112, or at least a part thereof, may thus be spectroscopically examined by the spectrometer device 116 as well as at least partially be imaged by the imaging device 120.

In step iii., the spectroscopic data 114 of step i. and the at least one item of image information 128 derived from the image data of step ii. are evaluated for obtaining the at least one item of object information 110 on the at least one object 112. Step iii. may specifically further comprise deriving the at least one item of image information 128 from the image data of step ii. As part of the evaluation, the spectroscopic data 114 and/or the item of image information may be analyzed, e.g. by applying at least one analysis step, e.g. an analysis step comprising at least one analysis algorithm applied to the data and/or information. Specifically, the spectroscopic data 114 and/or the item of image information may be processed and/or interpreted and/or assessed as part of the analysis step. As an example, the evaluation of the spectroscopic data 114 may comprise analyzing the spectroscopic data 114 to determine at least one peak 166 within the spectroscopic data 114 reflecting a global or local maximum of the transmission, the absorption, the reflection and/or the emission of the object 112. The evaluation of the spectroscopic data 114 may further comprise identifying the at least one corresponding wavelength. Furthermore, the evaluation of the spectroscopic data 114 may comprise determining the chemical composition of the object 112, e.g. by comparing the identified peaks 166 to at least one predetermined peak 166 or at least one predetermined set of peaks 166. The evaluation of the spectroscopic data 114 may specifically be performed using at least one spectroscopic evaluation algorithm. A result of the evaluation of the spectroscopic data 114 may also be referred to as spectroscopic object information 167. As an example, the evaluation of the item of image information 128 may comprise analyzing the item of image information 128 e.g. using at least one identification algorithm, specifically at least one object recognition algorithm as outlined in more detail further below.

The spectroscopic data 114 of step i. and the at least one item of image information 128 derived from the image data of step ii. are evaluated for obtaining the at least one item of object information 110 on the at least one object 112. The item object information 110 may specifically relate to at least one property of the object, such as at least one of a chemical, a physical and a biological property, e.g. a material and/or a composition of the object. As an example, a content of water and/or at least one other target component may be determined, e.g. a target component such as fat, sugar, in particular glucose, melanin, lactate and/or alcohol. In particular, the property may vary within the object 112, such that the property may be characteristic for a specific position or spatial range within the object 112. The property may, however, also show no or only slight variations throughout the object 112. The item of object information may describe the property in a qualitative and/or quantitative manner, e.g. by one or more numerical values. Specifically, the item of object information 110 may comprise chemical information, in particular a chemical composition, of the object 112. The item of object information 110 may comprise information on the property as well as spatial information on the specific position or spatial range within the object 112, where the property was measured. Thus, the evaluated spectroscopic data 114 and the evaluated item of image information 128 may be combined or connected, e.g. in a predetermined manner and/or according to a predetermined algorithm, for obtaining the at least one item of object information 110. The at least one item of image information 128 may comprise at least one of:
at least one image 164 derived from the image data of step ii.;
at least one item of spatial information 168 on the spatial measurement range 118 within the scene 124, specifically an indication 170 of the spatial measurement range 118 at which the spectroscopic data 114 was acquired within an image 164;
at least one item of identification information on the at least one object 112, specifically identification information on at least one of: a type of the object 112, a boundary of the object 112 within the scene 124, a size of the object 112, an orientation of the object 112, a color of the object 112, a texture of the object 112, a shape of the object 112, a contrast of the object 112, a volume of the object 112, a region of interest of the object 112;
at least one item of orientation information on the at least one object 112, specifically an indication of an orientation of the spectrometer device 116 relative to the at least one object 112;
at least one item of direction information, specifically an indication of a direction between the spectrometer device 116 and the at least one object 112;
at least one item of resemblance information on the object 112, specifically resemblance information on at least one shared property, which is shared between different regions of the object 112.

As an example for the method of obtaining at least one item of object information 110 on at least one object 112 by spectroscopic measurement, the at least one item of image information 128 may comprise the at least one image 164 derived from the image data of step ii. The image 164 specifically may comprise the image data mentioned in step ii., or a part thereof, and/or may be derived from the image data or a part thereof. As part of the method, steps i. and ii. may be performed repeatedly. The at least one item of object information 110 in step iii. may comprise a combination of spectroscopic object information 167 derived from the repetitions of step i. and at least one item of spatial information 168 on the spatial measurement range 118 within the scene 124 derived from the repetitions of step ii. The method may further comprise indicating at least one of the spatial information 168 and the spectroscopic object information 167 in the image 164. Thus, as an example, the image 164 may contain information on the location of the acquisition of the spectroscopic data 114 and/or the result of the evaluation of the spectroscopic data 114, e.g. composition information derived from the spectroscopic data 114. The image 164, thus, may visually indicate the scene 124, or a part thereof, as well as information derived from the spectroscopic data 114 acquired in step i., optionally with position information regarding the location of acquisition of the information. Thus, the image 164 may contain an overlap between the at least one object 112 visible in the scene 124, and one or more locations in which one or more spectroscopic measurements were performed, including, optionally, the results of the spectroscopic measurements and/or one or more items of information derived from the spectroscopic measurements. FIG. 2B and FIG. 3 both show examples of images 164 of one or more of the at least one object 112, wherein the locations, in which one or more spectroscopic measurements were performed on the objects 112, are marked. Further shown is information in the form of spectral curves 150, which are derived from the spectroscopic measurement. Both Figures will be described in more detail below.

Between the possible repetitions of steps i. and ii., at least one of the scene 124, the field of view 126 and the object 112 may be modified. Thus, as an example, the scene 124 may vary, and/or at least one of the spectrometer device 116, the imaging device 120 and a device comprising both the spectrometer device 116 and the imaging device 120, such as a mobile device 136, as discussed above, may be moved. Particularly, the method may generate the at least one image 164 of the scene 124 with at least two items of spectroscopic object information 167 and corresponding spatial information 168 on the spatial measurement range 118 within the image for each item of spectroscopic object information 167. Further, the image 164 derived from the image data of step ii. may be an image 164 derived from the image data of the repetitions of step ii., specifically at least one of a combined image 164 and a selected image 164 of images 164 derived from the image data of the repetitions of step ii.

FIG. 2B, as outlined above, shows in an exemplary fashion two items of object information 110 on two different objects 112, specifically on the apple and the banana. The item of object information 110 on the apple may comprise the spectral curve 150 determined by evaluating the spectroscopic data 114, which may e.g. be acquired in a spectroscopic measurement of the apple as illustrated in FIG. 2A. The item of object information 110 on the apple may further comprise the image 164 showing the apple as part of the scene 124 imaged by the imaging device 120. The item of object information 110 may further comprise the indication 170 indicating within the image 164 the position of the spatial measurement range 118 at which the spectroscopic data 114 were acquired. In an analogous fashion, the item of object information 110 on the banana may comprise the spectral curve 150 determined by evaluating the spectroscopic data 114, which may e.g. be acquired in a spectroscopic measurement of the banana (not shown). The item of object information 110 on the banana may further comprise the image 164 showing the banana as part of the scene 124 imaged by the imaging device 120 and the indication 170 indicating within the image 164 the position of the spatial measurement range 118 at which the spectroscopic data 114 were acquired. It shall be noted that a position of the smart phone 138 when taking the image 164 showing the apple and the banana may differ from a position in which the spectroscopic data 114 of e.g. the apple was acquired. Specifically, the imaging device 120 and/or the spectrometer device 116 may be moved between, specifically during, the optional repetitions of steps i. and ii. Specifically, in an initial performance of step ii. image data of a first scene 124 may be acquired at a first distance, wherein for the repetitions of step ii. the imaging device 120 and/or the spectrometer device 116 may be moved closer to the object 112 such that the imaged scenes 124 are sub-sections of said first scene 124. In particular, image data corresponding to a wide image 164 may be acquired in the initial performance of step ii. as depicted in FIG. 2B and in FIG. 3. The wide image 164 may comprise the object 112 fully or almost fully. For the further repetitions of step ii. and/or step i. the distance of the imaging device 120 and/or the spectrometer device 116 to the object 112 may be reduced to at least one second distance, wherein the second distance may allow acquiring spectroscopic data 114 of the object 112 by performing step i. In particular, the second distance may be in the range from 0 mm to 100 mm from the object 112, specifically in the range from 0 mm to 15 mm. The images 164 derived from the image data acquired at the second distance may show sub-sections of the image 164 derived from the image data acquired in the initial performance of step ii. The method may further comprise tracking a movement of the imaging device 120, e.g. from the first distance to the at least one second distance, by using the imaging device 120 and a motion tracking software. Specifically, the spatial relation between the image data and/or the spectroscopic data 114 acquired at the at least one second distance with the image data acquired at the first distance may be deduced, e.g. taking into account orientation information and/or direction information derived from the image data. The item of object information 110 may connect the spectroscopic object information 167, e.g. the chemical composition as determined using the spectroscopic data 114, to the item of spatial information 168 identifying in the image 164 the site of the object 112 for which the spectroscopic object information 167 is valid. The site of the object 112 may be identified in the image 164 by at least one graphical indication 170 such as an arrow pointing to the site or by a circle, a square or another type of indication 170 encircling or marking the site. One or several such sites may be marked in the image 164 and the corresponding spectroscopic object information 167 shown.

As a further example, illustrated in FIG. 3, the imaging device 120 and/or the spectrometer device 116 may be moved across the object 112, such as in a fixed distance and/or in a variable distance, e.g. along a scanning path 172, while performing repetitions of steps i. and ii. By performing step iii., the at least one item of object information 110 may be obtained, wherein the object information 110 may in particular comprise a plurality of items of chemical information corresponding to a plurality of sites along the scanning path 172. Again, image data of the object 112 may be acquired, e.g. in an initial performance of step ii., wherein the scanning path 172 may be comprised by the image 164 derived from the image data. Specifically, the scanning path 172 and/or the spectroscopic object information 167, specifically the chemical information, may be indicated in the image 164. This may allow to retrieve the chemical information along the scanning path 172. In the example illustrated in FIG. 3, spectroscopic object information 167 in the form of three spectral curves 166 are shown together with the three different sites at which the spectral data 114 were acquired.

As a further example, the item of image information 128 may comprise at least one item of identification information on the at least one object 112, specifically identification information on at least one of: the type of the object 112, the boundary of the object 112 within the scene 124, the size of the object 112, the orientation of the object 112, the color of the object 112, the texture of the object 112, the shape of the object 112, the contrast of the object 112, the volume of the object 112, the region of interest of the object 112. The item of identification information may in particular be derived by using at least one identification algorithm, such as by an image recognition algorithm and/or a trained model configured for recognizing or identifying the object 112, e.g. by using artificial intelligence, such as an artificial neural network. In particular, the at least one item of image information may comprise the at least one item of identification information on the at least one object 112, wherein the method comprises applying the at least one identification algorithm to the at least one item of image information 128 for deriving the at least one item of identification information from the at least one item of image information 128. The identification algorithm may specifically comprise at least one object recognition algorithm for determining the type of the at least one object 112. For example, the object recognition algorithm may identify the type of the object 112. For the example illustrated in FIGS. 2A and 2B, the type of the object 112 may be identified as being an apple respectively a banana. For the example illustrated in FIG. 3, the type of the object 112 may be identified as being a human hand and arm. Specifically, step iii. may comprise applying at least one spectroscopic evaluation algorithm to the spectroscopic data 114 of step i., wherein the spectroscopic evaluation algorithm is selected in accordance with the item of identification information, specifically in accordance with the type of the at least one object 112. The method may in particular comprise providing a plurality of spectroscopic evaluation algorithms for different items of identification information, specifically for different types of objects 112. Thus, depending on the type of object 112 as determined by the identification algorithm, a corresponding spectroscopic evaluation algorithms may be chosen such that information determined from the image data may subsequently be used for the evaluation of the spectroscopic data 114. As an example, the item of image information may comprise the item of identification information identifying the object 112 whose spectroscopic data 114 were acquired as being an apple. Accordingly, the spectroscopic data 114 may be evaluated using a spectroscopic evaluation algorithm optimized for the evaluation of apples. Using application-specific spectroscopic evaluation algorithms may increase accuracy of the evaluation result, e.g. the chemical composition of the object 112, and/or accelerate the evaluation process.

Additionally or alternatively, the item of image information may comprise identification information on the size of the object 112. Thus, the image information may comprise identification information on both the type and the size of the object 112. The different items of identification information may be combined and create added value. As an example, the object 112 may be identified as an apple and the size of the apple may be derived from the image data. Based on these items of information an estimated weight of the apple may be determined. To obtain the item of object information 110, this information may be combined with the chemical composition as determined by evaluating the spectroscopic data 114 to deduce at least one item of nutritional information such as the nutritional values per portion.

The method may be at least partially computer-implemented, specifically step iii. The computer-implemented steps and/or aspects of the invention, may particularly be performed by using a computer or computer network. As an example, step iii. of the method may be fully or partially computer-implemented. Thus, the evaluation of the spectroscopic data may specifically be performed using at least one spectroscopic evaluation algorithm. The evaluation of the item of image information may comprise analyzing the item of image information e.g. using at least one identification algorithm. The evaluated spectroscopic data and the evaluated item of image information may be combined or connected, e.g. in a predetermined manner and/or according to a predetermined algorithm, for obtaining the at least one item of object information. The at least one spectroscopic evaluation algorithm may in particular comprise at least one trained model. The method may further comprise providing the at least one item of object information 110 on the at least one object 112, specifically optically providing the at least one item of object information 110 on the at least one object 112 via a display device 174. Specifically, the item of object information 110 may be displayed e.g. on a display device 174 such as a screen 176 of a mobile device 136, e.g. the mobile device 136 that may comprise the imaging device 120 and/or the spectrometer device 116.

As outlined above, FIG. 2A shows the system 178 for obtaining the at least one item of object information 110. The system 178 specifically may comprise a smart phone 138. FIG. 2A shows the system 178 for obtaining at least one item of object information 110 during the performance of step i. of the method of obtaining at least one item of object information 110. The evaluation unit 180 of the system 178 for obtaining at least one item of object information 110 may specifically be configured for analyzing spectroscopic data 114 and/or image data, specifically the item of image information 128. The evaluation unit 180 may specifically process and/or interpret and/or assess the data and/or information as part of the analysis process. The evaluation unit 180 may in particular comprise at least one processor 182. The processor 182 may specifically be configured, such as by software programming, for performing one or more evaluation operations on the data and/or information. As shown in FIG. 2A, the system 178 may comprise at least one display device 174, e.g. the screen 176 of the mobile device 136, configured for providing the at least one item of object information 110 on the at least one object 112.

The system 178 may further comprise at least one control unit 186. The control unit 186 may specifically be configured for performing at least one computing operation and/or for controlling at least one function of at least one other component of the system 178 for obtaining at least one item of object information 110. The control unit 186 may specifically control at least one function of the spectrometer device 116, e.g. the acquiring of spectroscopic data 114. The control unit 186 may specifically control at least one function of the imaging device 120, e.g. the acquiring of image data. The control unit 186 may specifically control at least one function of the evaluation unit 180, e.g. the evaluation of the spectroscopic data 114 and/or the evaluation of the at least one item of image information 128. Specifically, the at least one control unit 186 may be embodied as at least one processor 188 and/or may comprise at least one processor 188, wherein the processor 188 wherein the processor may be configured, specifically by software programming, for performing one or more operations.

### LIST OF REFERENCE NUMBERS

110 item object information
112 object
114 spectroscopic data
116 spectrometer device
118 spatial measurement range
120 imaging device
122 camera
124 scene
126 field of view
128 item of image information
130 step i.
132 step ii.
134 step iii.
136 mobile device
138 smart phone
140 light
142 light source
144 detector device
146 optical element
148 photosensitive element
150 spectral curve
152 y-axis
154 x-axis
156 food item
158 fruit
160 body part
161 housing
162 skin
163 front camera
164 image
165 rear camera
166 peak
167 item of spectroscopic object information
168 item of spatial information
170 indication
172 scanning path
174 display device
176 screen
178 system for obtaining at least one item of object information
180 evaluation unit
182 processor
184 wavelength-selective element
186 control unit
188 processor

1. A method of obtaining at least one item of object information on at least one object by spectroscopic measurement, the method comprising:
i. acquiring spectroscopic data by using at least one spectrometer device, within at least one spatial measurement range of the spectrometer device;
ii. acquiring, by using at least one imaging device, image data of a scene within a field of view of the imaging device, the scene comprising at least a part of the object and at least a part of the spatial measurement range of the spectrometer device; and
iii. evaluating the spectroscopic data of step i. and at least one item of image information derived from the image data of step ii., for obtaining the at least one item of object information on the at least one object, wherein the item of image information comprises at least one item of resemblance information on the object, wherein the method comprises predicting spectroscopic data and/or at least spectroscopically derivable property for regions of the object, which resemble each other in at least one property of the image data.

2. The method according to claim 1, wherein the at least one item of image information comprises at least one of the following:
at least one image derived from the image data of step ii;
at least one item of spatial information on the spatial measurement range within the scene;
at least one item of identification information on the at least one object;
at least one item of orientation information on the at least one object;
at least one item of direction information; and
at least one item of resemblance information on the object.

3. The method according to claim 1, wherein the at least one item of image information comprises at least one image derived from the image data of step ii., wherein steps i. and ii. are performed repeatedly, wherein the at least one item of object information in step iii. comprises a combination of spectroscopic object information derived from the repetitions of step i. and at least one item of spatial information on the spatial measurement range (118) within the scene derived from the repetitions of step ii., wherein the method comprises indicating at least one of the spatial information and the spectroscopic object information in the image.

4. The method according to claim 3, wherein, between the repetitions of steps i. and ii., at least one of the scene, the field of view and the object is modified.

5. The method according to claim 3, wherein the method generates the at least one image of the scene with at least two items of spectroscopic object information and corresponding spatial information on the spatial measurement range within the image for each item of spectroscopic object information.

6. The method according to claim 3, wherein the image derived from the image data of step ii. is an image derived from the image data of the repetitions of step ii.

7. The method according to claim 1, wherein the at least one item of image information comprises at least one item of identification information on the at least one object, wherein the method comprises applying at least one identification algorithm to the at least one item of image information for deriving the at least one item of identification information from the at least one item of image information.

8. The method according to claim 7, wherein step iii. comprises applying at least one spectroscopic evaluation algorithm to the spectroscopic data of step i., wherein the spectroscopic evaluation algorithm is selected in accordance with the item of identification information.

9. The method according to claim 8, wherein the method comprises providing a plurality of spectroscopic evaluation algorithms for different items of identification information.

10. The method according to claim 1, wherein the method further comprises providing the at least one item of object information on the at least one object.

11. A system for obtaining at least one item of object information on at least one object by spectroscopic measurement, the system comprising
I. at least one spectrometer device configured for acquiring spectroscopic data within at least one spatial measurement range of the spectrometer device;
II. at least one imaging device configured for acquiring image data of a scene within a field of view of the imaging device, the scene comprising at least a part of the object and at least a part of the spatial measurement range of the spectrometer device; and
III. at least one evaluation unit configured for evaluating the spectroscopic data acquired by the spectrometer device and at least one item of image information derived from the image data acquired by the imaging device, for obtaining the at least one item of object information on the at least one object, wherein the item of image information comprises at least one item of resemblance information on the object, wherein the evaluation unit is configured for predicting spectroscopic data and/or at least spectroscopically derivable property for regions of the object, which resemble each other in at least one property of the image data.

12. The system according to claim 11, wherein the spectrometer device and the imaging device have a known orientation with respect to each other.

13. The system according to claim 11, further comprising at least one display device configured for providing the at least one item of object information on the at least one object.

14. A computer program comprising instructions which, when the program is executed by a control unit of a system, cause the system to perform the method according to claim 1.

15. A computer-readable storage medium comprising instructions which, when the program is executed by a control unit of a system, cause the system to perform the method according to claim 1.

16. The method according to claim 1, wherein the at least one imaging device is a camera.

17. The method according to claim 1, wherein the at least one item of image information comprises at least one of the following
at least one image derived from the image data of step ii;
at least one item of spatial information on an indication of the spatial measurement range at which the spectroscopic data was acquired within an image;
at least one item of identification information on at least one of a type of the object, a boundary of the object within the scene, a size of the object, an orientation of the object, a color of the object, a texture of the object, a shape of the object, a contrast of the object, a volume of the object, or a region of interest of the object;
at least an indication of an orientation of the spectrometer device relative to the at least one object;
at least an indication of a direction between the spectrometer device and the at least one object; and
at least one item of resemblance information at least one shared property, which is shared between different regions of the object.

18. The method according to claim 3, wherein at least one of a combined image and a selected image of images derived from the image data of the repetitions of step ii.

19. The method according to claim 7, wherein step iii. comprises applying at least one spectroscopic evaluation algorithm to the spectroscopic data of step i., wherein the spectroscopic evaluation algorithm is selected in accordance with the type of the at least one object.

20. The system according claim 11, wherein the at least one imaging device is a camera.
